(19) United States
(12) Patent Application Publication
(10) Pub. No.: US 2024/0383474 A1
(43) Pub. Date: Nov. 21, 2024

(54) VEHICLE CONTROL DEVICE AND METHOD

(71) Applicant: HL Klemove Corp., Incheon (KR)

(72) Inventor: Taesik YOON, Siheung-si (KR)

(21) Appl. No.: 18/388,024

(22) Filed: Nov. 8, 2023

(30) Foreign Application Priority Data
May 18, 2023 (KR) 10-2023-0064426

(51) Int. Cl. B60W 30/12; B60W 10/20; B60W 40/072; B60W 60/00; G06V 20/56

(52) U.S. Cl. CPC B60W 30/12; B60W 10/20; B60W 40/072; B60W 60/001; G06V 20/588; B60W 2420/403; B60W 2552/30; B60W 2552/53

(57) ABSTRACT

A vehicle control device includes a sensor device for detecting a branch road guide line marked on a road surface of a driving lane, a route guidance device configured to generate a target route to a destination and provide information on the target route, a lane keeping control module configured to perform a lane keeping control The vehicle control device further includes a controller configured to, in response to a plurality of branch road guide lines being detected in the driving lane, control the lane keeping control module based on a position of at least one of the plurality of branch road guide lines and a position of a left lane or a right lane of the driving lane depending on the presence or absence of a target route set by the route guidance device.

### CROSS REFERENCE TO RELATED APPLICATION

This application claims priority from Patent Korean Application No. 10-2023-0064426, filed on May 18, 2023, which is hereby incorporated by reference herein in its entirety.

### TECHNICAL FIELD

Embodiments of the present disclosure relate to a vehicle control device and method. More specifically, the embodiments of the present disclosure relate to a vehicle control device and method capable of perform a lane keeping control on branch roads.

### BACKGROUND

An electric power steering device basically performs an operation of generating a steering assist current to be proportional to the steering torque according to a driver's operation of the steering wheel so as to rotate the electric motor. That is, the electric power steering apparatus performs a basic operation for assisting the user's steering force.

However, according to the development of a Driving Assistance System (DAS) and a demand for autonomous traveling or the like, an autonomous steering control or an active steering control has been recently developed which automatically operates the electric power steering system regardless of the user's intention, in addition to a basic function of simply assisting the driver's steering force.

According to the autonomous steering control or the active steering control, there are various control systems related to steering, which affect the electric power steering system of a vehicle.

An example of the control system related to the steering of a vehicle includes a Lane Keeping Assistance System (LKAS) configured to sense a lane to control the vehicle to travel along the lane, and to operate a steering system regardless the driver's operation to keep the lane when lane departure is concerned.

In addition, as another example of the control system related to the steering of a vehicle, there is a Lane Departure Warning System (LDWS) configured to sense a lane and the current position of the vehicle and to then warn of a lane departure state when the vehicle departs from a predetermined range adjacent to the lane.

The above mentioned LKAS and LDWS may be integrated with each other so as to implement a single system, and in such an integrated lane control system may include both of a function of making a warning when there is the possibility of a lane departure and a function of actively controlling the steering systems to keep the lane.

Meanwhile, there is used a navigation device which generates a set route from a current location to a destination when a driver inputs a destination and guides the created set route.

In addition, according to the recent development of technology, there is developed a fully autonomous driving or semi-autonomous driving technology which automatically performs steering control, braking control, and engine control (speed control) so that the vehicle travels along the route set by the navigation device.

Meanwhile, in the case that there is one or more branch roads on a highway or a motorway, a branch road guide line having a specific color or shape may be displayed on a surface of a road to guide vehicles to each branch road.

The branch road guide line may start from a position in the current driving road and extend to each part of the branch road.

In addition, if there are two or more branch roads within a specific section, the branch road guide line for each branch road may be distinguished by having different colors or shapes.

In the case that a vehicle drives on a road with two or more branch road guide lines in one lane, there is required to precisely perform autonomous driving control or lane keeping control of a vehicle according to the presence or absence of a set route created by a navigation device.

### SUMMARY

In this background, an object of the embodiments of the present disclosure is to provide a vehicle control device and method capable of controlling a vehicle in a desired direction on a branch road.

Another object of the embodiments of the present disclosure is to provide a vehicle control device and method capable of appropriately performing autonomous driving control or lane keeping control within a corresponding lane depending on the presence or absence of a preset target route.

Another object of the embodiments of the present disclosure is to provide a vehicle control device and method which enables a vehicle to follow one of two or more branch road guide lines according to the presence or absence of a target route set by a navigation device.

Another object of the embodiments of the present disclosure is to provide a vehicle control device and method which enables autonomous driving of a vehicle on a road marked with two or more branch road guide lines.

In accordance with an aspect of the present disclosure, there is provided a vehicle control device including a sensor device configured to detect a branch road guide line marked on a road surface of a driving lane, a route guidance device configured to generate a target route to a destination and provide information on the target route, a lane keeping control module configured to perform a lane keeping control, and a controller configured to, in response to a plurality of branch road guide lines being detected in the driving lane, control the lane keeping control module based on (i) a position of at least one of the plurality of branch road guide lines and (ii) a position of a left lane or a right lane of the driving lane depending on the presence or absence of a target route set by the route guidance device.

For example, in response to the target route being set, the controller is configured to control the lane keeping control module to cause a vehicle to drive along a branch road guide line corresponding to the target route among the plurality of branch road guide lines.

Specifically, in response to the target route is set, the controller is configured to control the lane keeping control module to cause an outer line of the vehicle to be located at a midpoint position between one side of the branch road guide line corresponding to the target route among the plurality of branch road guide lines and one side of the left lane or right lane of the driving lane.

When the target route is not set, the controller is configured to control the lane keeping control module to cause a vehicle to drive along a branch road guide line corresponding to a road branching later among the plurality of branch road guide lines.

As another example, when the target route is not set, the controller is configured to control the lane keeping control module to cause a vehicle to drive along at least one of a branch road guide line having a large radius of curvature among the plurality of branch road guide lines, a branch road guide line on a side indicated by a turn signal lamp, or a branch road guide line on a side of a line of sight of a driver.

The plurality of branch road guide lines are each distinguished by a different color or pattern.

In addition, the plurality of branch road guide lines includes a first branch road guide line corresponding to a first branch road branching first and a second branch road guide line corresponding to a second branch road branching later.

In this case, each of the first branch road guide line and the second branch road guide line is a line having the same width, and the first branch road guide line and the second branch road guide line is spaced apart by a first distance within the driving lane and disposed on the left and right.

The route guidance device includes a navigation device built into the vehicle or a portable terminal a vehicle occupant or a driver, and the controller is configured to receive information about the target route from the route guidance device.

The sensor device is configured to identify each of the plurality of branch road guide lines based on a width of a branch road guide line marked in the driving lane and a color or a pattern of the branch road guide line marked in the driving lane.

In addition, the sensor device is configured to further detect a branching guide lane marked in the driving lane with the plurality of branch road guide lines.

In this case, the controller is configured to control the lane keeping control module to ignore the branching guide lane detected within the driving lane.

In accordance with another aspect of the present disclosure, there is provided a vehicle control device including a steering device configured to control a driving direction of a vehicle, and an autonomous driving controller configured to control an autonomous driving of the vehicle by controlling the steering device without an intervention of a driver, wherein the autonomous driving controller is configured to detect a plurality of branch road guide lines marked on a road surface of one driving lane in which a vehicle travels based on information from an image sensor mounted in the vehicle, and adjust a lateral position of the vehicle within the one driving lane by automatically controlling the steering device based on one or more of the plurality of branch road guide lines depending on the presence or absence of a target route set for autonomous driving of the vehicle.

In accordance with another aspect of the present disclosure, there is provided a vehicle control method including detecting a branch road guide line marked on a road surface within one driving lane, generating a target route to a destination and providing information on the target route, and adjusting, in response to a plurality of branch road guide lines being detected within the one driving lane, a lateral position of a vehicle in the one driving lane based on a position of at least one of the plurality of branch road guide lines and a position of a left lane or a right lane of the one driving lane depending on the presence or absence of the target route.

According to the embodiments of the present disclosure, it is possible to control driving of a vehicle in a desired direction in an environment where a plurality of branch roads exist.

In addition, according to the embodiments of the present disclosure, it is possible to appropriately perform, when a vehicle drives in a lane marked with two or more branch road guide lines, an autonomous driving control or a lane keeping control within the corresponding driving lane depending on the presence or absence of a preset target route.

In addition, according to the embodiments of the present disclosure, the vehicle may appropriately follow one of two or more branch road guide lines depending on the presence or absence of a target route set by the navigation device.

In addition, according to the embodiments of the present disclosure, the autonomous driving of a vehicle is possible in a road environment marked with two or more branch road guide lines within one driving lane.

### BRIEF DESCRIPTION OF THE DRAWINGS

FIG. 1 is a functional block diagram of a vehicle control device according to some embodiments of the present disclosure.

FIG. 2 illustrates a road environment to which some embodiments of the present disclosure are applied.

FIG. 3 illustrates an example of a road with a plurality of branch road guide lines marked on a road surface.

FIG. 4 illustrates an example of an operation of a vehicle control device according to some embodiments of the present disclosure in the case that a target route is set.

FIG. 5 illustrates another example of an operation of a vehicle control device according to some embodiments of the present disclosure in the case that a target route is set.

FIG. 6 illustrates an example of an operation of a vehicle control device according to some embodiments of the present disclosure in the case that a target route is not set.

FIG. 7 illustrates another example of an operation of a vehicle control device according to some embodiments of the present disclosure in the case that a target route is not set.

FIG. 8 illustrates an example of a configuration for following a branch road guide line of a vehicle control device according to some embodiments.

FIG. 9 is a flowchart of a vehicle control method according to some embodiments of the present disclosure.

FIG. 10 is a configuration diagram of a vehicle control device for autonomous driving according to some embodiments of the present disclosure.

FIG. 11 illustrates an example of a hardware configuration of a vehicle control device according to some embodiments of the present disclosure.

### DETAILED DESCRIPTION

In the following description of examples or embodiments of the present t disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, it will be described the embodiments in detail with reference to the drawings.

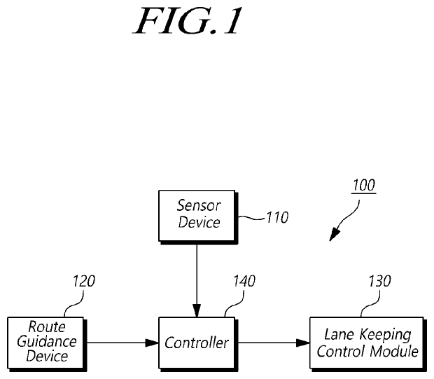

FIG. 1 is a functional block diagram of a vehicle control device according to some embodiments of the present disclosure.

A vehicle control device 100 according to some embodiments includes a sensor device 110, a route guidance device 120, a lane keeping control module 130, and a controller 140.

The sensor device 110 is configured to detect one or more branch road guide lines marked on a road surface of a driving lane in which the vehicle is traveling.

The sensor device 110 is an image sensor such as a camera or the like, but may also be a laser ranging sensor such as a Lidar.

However, the sensor device 110 according to the embodiments of the present disclosure is required to have a function capable of further identifying a branch road guide line marked between the left and right lanes in addition to the general lane by recognizing the color and/or pattern of the mark displayed on the road surface of the driving lane.

The sensor device 110 is an image sensor such as a camera mounted on a vehicle.

Such an image sensor is a front camera installed at the rear of a vehicle windshield to capture an image of a front view of the vehicle, and includes any type of capturing device such as a CCD or MOSFET type.

Such an image sensor includes an imaging module which processes a captured image and outputs information such as a position, type, and distance of an object in the image, in addition to a simple image capturing function.

In addition, the sensor device 110 is configured to identify the branch road guide line disposed between left and right lanes of the driving road by using output information of an image sensor.

According to some embodiments of the present disclosure, the sensor device 110 performs both an image acquisition function and a lane and the branch road guide line detection function based on image processing.

However, the present disclosure is not limited thereto, and according to some embodiments of the present disclosure, an image processing processor module having a function of identifying/detecting a lane and the branch road guide lines based on image data obtained from an image sensor is provided separately from the sensor device 110.

As an example, the sensor device 110 is configured to remove an obstacle from an image based on distance data obtained by a distance sensor such as a radar device, set an area from which the obstacle is removed as a free space, and detect an edge of an image within that free space.

In some embodiments, the sensor device 110 is configured to use a specific edge detection algorithm for edge detection. For example, the sensor device 110 is configured to use a Sobel filter that is more effective for detecting a diagonal edge than a vertical edge or a horizontal edge, but is not limited thereto.

The sensor device 110 is configured to detect an edge (horizontal edge, vertical edge, diagonal edge, etc.) of an object included in an image, and detect a linear component from the edge information using a Hough Transform algorithm.

Thereafter, the sensor device 110 is configured to set at least one region of interest (ROI) necessary for recognizing a lane and the branch road guide line based on a result of detecting a linear component in the free space.

In some embodiments, a region of interest necessary for recognizing lanes and branch road guide lines includes regions corresponding to lanes and branch road guide lines, but is set to minimize an image search range for lane recognition.

For example, since the lane and the branch road guide lines are located in the lower part of the image, the region of interest is set to a part of the lower region of the acquired image.

In addition, since the lane and the branch road guide lines appear smaller as the distance increases, the size of the region of interest is set to decrease as the lane becomes smaller.

In addition, in some embodiments, the region of interest is separately set for each of the left lane, the right lane, and the branch road guide line disposed between the left and right lanes of the driving road.

If a region of interest for lane recognition is set, the sensor device 110 extracts the lane and the branch road guide lines in the set region of interest. If the lanes are extracted from the regions of interest, the sensor device 110 detects a vanishing point of the lane.

The sensor device 110 is configured to estimate a heading angle of the vehicle by comparing a location of the detected vanishing point with a location of the center point of the image.

That is, if the vanishing point of the lanes on both sides of the driving road coincides with the center point of the camera image, the heading angle of the vehicle is 0, which indicates that the vehicle travels in the same direction as the driving direction of the lane. In addition, there may be estimated a vehicle heading angle indicating an angle between a vehicle traveling direction and a direction of the lane from an offset between a vanishing point and a center point of the image.

Accordingly, the heading angle of the vehicle estimated by the sensor device 110, as will be described below, will be used as a parameter for controlling the steering of the vehicle with respect to the branch road guide line depending on the presence or absence of the target route.

In addition, the sensor device 110 according to some embodiments is configured to identify the branch road guide line having a specific pattern and/or color displayed on the road surface between the left and right lanes, in addition to the left and right lanes of the driving lane.

To this end, the sensor device 110 is configured to detect a color of the branch road guide line by using a deep learning model for lane classification.

As an example, the sensor device 110 is configured to identify a first mark having a color other than white displayed on a road, and identify the color of the first mark by determining the most dominant color coordinate among red (R), green (G), and blue (B) of the first mark.

In addition, the sensor device 110 is configured to identify a shape of a mark displayed on a road or a pattern inside the mark.

For example, the sensor device 110 is configured to identify a general lane in which white straight segments are intermittently disposed.

In addition, the sensor device 110 is configured to identify a central separation line that is a yellow straight extension line.

In addition, the sensor device 110 according to some embodiments of the present disclosure is configured to identify the branch road guide line as a pink or green solid line.

As an example, the branch road guide line is a guide line having a different color, and further includes a unique pattern therein.

In Korea, the branch road guide lines are displayed as pink or green solid lanes, and arrow patterns arranged at regular intervals inside the branch road guide line are further included.

The branch road guide line is a solid lane divided into a specific color and generally have a larger width than a general lane or a central separation line.

In addition, in the case that a plurality of branch road guide lines are displayed in one lane or an adjacent lane, the plurality of branch road guide lines is distinguished from each other by the different colors or patterns, respectively.

The plurality of branch road guide lines includes a first branch road guide line corresponding to a first branch road which branches first and a second branch road guide line corresponding to a second branch road which branches later.

In this case, each of the first branch road guide line and the second branch road guide line is a unique color solid line having the same width, and the first branch road guide line and the second branch road guide line are spaced apart from each other by a first distance and disposed on left and right sides of the driving lane.

For example, according to some embodiments, in the case that two or more branch road guide lines are marked or displayed within one road or one lane, the first branch road guide line disposed on the left side is a solid green line having a width of 45 to 50 cm, and the second branch road guide line disposed on the right side is a pink solid line having a width of 45 to 50 cm and spaced apart from the first branch road guide line by about 40 cm.

In some embodiments, a specific white pattern such as an arrow is further included inside the first branch road guide line and the second branch road guide line.

Therefore, the sensor device 110 is configured to identify each of the branch road guide lines based on the size (45 to 50 cm) of the width, color (green or pink), the internal pattern of the branch road guide line.

In addition, the sensor device 110 used in some embodiments includes a front camera module.

Such a front camera module is configured to calculate and output the shape of an edge of a lane or mark displayed on a road and location information (coordinates, etc.) of the edge based on image information captured around the vehicle.

In addition, since such a front camera module is installed in the center of the front of the vehicle, it is possible to output location information (coordinates, etc.) of the center in the lateral direction, which is the center between the left and right lines of the vehicle.

In addition, the front camera module is configured to calculate and output a heading angle, which is an angle formed between a direction of a lane on one side of the driving lane and the traveling direction of the vehicle.

The front camera module is configured to recognize a lane of a driving lane, and output curvature or radius of curvature information of the lane, direction information of the lane, and the like.

Meanwhile, as will be described later, since the vehicle control device according to some embodiments of the present disclosure operates on a branch road, the vehicle control device further has a function of detecting a “disappearing” state of a lane that suddenly becomes unrecognized after one of the lanes on both sides of the driving road is recognized, and then detecting a long-distance lane existing in the direction of the disappearance side.

To this end, the sensor device 110 has a function of expanding a region of interest in the direction of the disappearance side if one of the lanes on both sides of the driving road disappears.

That is, in a normal driving state, the sensor device 110 is configured to set a region of interest of the same size on both sides of the driving road, but if one of the lanes on both sides of the driving road is disappeared, the sensor device 110 further expands the region of interest in the direction of the disappearance side and recognizes a long-distance lane or a lane of the branch road of the disappearance side.

Of course, as will be described later, in the case that the vehicle travels along a branch road in a road branching area, there is required to further expand the region of interest in the direction of the non-disappearance side. Therefore, the sensor device 110 according to some embodiments of the present disclosure is configured to expand and reconfigure the region of interest to both the disappearance side and the non-disappearance side if one of the lanes on both sides of the driving road is disappeared.

In addition, the sensor device 110 is configured to calculate the distance to the lane included in the captured image frame and location information of the lane in consideration of a focal length and magnification ratio of the camera.

The route guidance device 120 included in the vehicle control device 100 according to some embodiments of the present disclosure is configured to generate a target route to a destination and provide information on the target route.

The route guidance device 120 is a navigation device built into the vehicle or a portable terminal of a vehicle occupant or driver.

In addition, the vehicle driver may input a desired destination by manipulating the route guidance device 120, and the route guidance device is configured set a target route which is an optimal route to the input destination and display the target route.

In addition, the route guidance device 120 is configured to output information on the target route to the controller 140 as will be described later.

The route guidance device 120 is a navigation device, and the navigation device includes map information.

After detecting the current location of the vehicle using a positioning means such as GPS, the navigation device is configured to display current vehicle location information and driving-related information along with map information.

Such a navigation device is embedded in a vehicle or is additionally mounted in a vehicle as a separate device, and all types of navigation devices may be used in the embodiments of the present disclosure.

However, the navigation device applicable to some embodiments includes map information therein, and transmits the information on the target route used in the present embodiment to the controller 140 or the autonomous driving controller by using a predetermined information transmission/reception means (wireless communication module, wired communication cable).

More specifically, the information on the target route output by the navigation device according to some embodiments of the present disclosure includes the number of lanes on the driving road, intersection area information existing on the driving road, crosswalk area information, tollgate or high-pass area information, road merging information or road branching information.

In particular, since the vehicle control device according to some embodiments of the present disclosure controls vehicle driving on a road branching area, information on the target route further includes information on one or more branch roads.

In addition, the information on the target route further includes information on one or more branch road guide lines.

The lane keeping control module 130 included in the vehicle control device 100 according to some embodiments of the present disclosure is configured to automatically control steering of the vehicle under the control of the controller 140 so as to control the lateral position of the vehicle within the lane.

The lane keeping control module 130 includes a lane keeping assist system (LKAS) module.

The lane keeping control module 130 is configured to control a lateral position of the vehicle so that an outer line of the vehicle is located at the midpoint between a point of one side of one of the two branch road guide lines marked in the driving lane and a position of one side of the left lane or right lane of the driving lane. In this case, according to some embodiments, the outer line of the vehicle is defined as the coordinates of the leftmost position or the rightmost position of the vehicle body. The coordinates of the outer line of the vehicle, that is, the leftmost or rightmost position of the vehicle body, are determined based on the center position of the vehicle in the lateral direction and the vehicle width information.

Specifically, the lane keeping control module 130 is configured to, under the control of the controller 140, drive a steering device of the vehicle by using a heading angle of the vehicle, vehicle width information, a position of the branch road guide line, a position of the left and right lanes, a curvature (radius) of the road, and the like as parameters. In addition, the lane keeping control module 130 is configured to control the vehicle to travel along one of the two branch road guide lines in the driving lane by adjusting the lateral position of the vehicle within the driving lane.

As an example, in some embodiments, the lane keeping control module 130 is controlled so as for the outer line of the vehicle to be positioned at a midpoint between a position of one side of one of the two branch road guide lines in the vehicle driving lane and a position of one side of the left lane or right lane of the driving lane by using a heading angle of the vehicle, vehicle width information, a position of the branch road guide line, a position of the left and right lanes, and a curvature (radius) of the road as parameters.

Such a lane keeping control module 130 is referred as a lane following assist (LFA) control module.

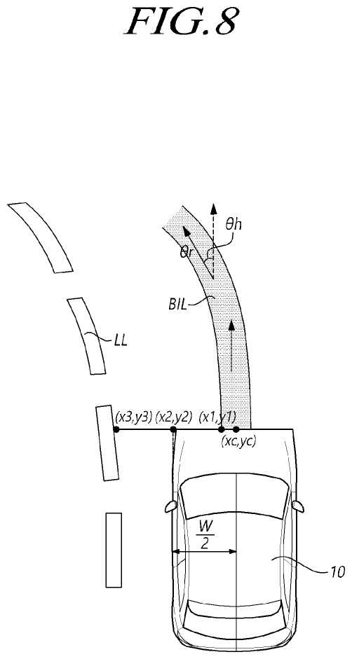

It will be described a detailed configuration of the control of the vehicle's lateral position through the lane keeping control module 130 in more detail below based on FIG. 8.

The controller 140 included in the vehicle control device 100 according to some embodiments of the present disclosure is configured to control, if a plurality of branch road guide lines are detected in the driving lane, the lane keeping control module based on positions of at least one of the plurality of branch road guide lines depending on the presence or absence of a target route set by the route guidance device.

Specifically, the controller 140 is configured to perform, i) a first function for determining whether a plurality of branch road guide lines exists within a driving lane based on data from a sensor device, ii) a second function for determining whether a target route set by a driver exists, and iii) a third function of adjusting a lateral position of the vehicle within the corresponding lane based on the branch road guide lines according to the presence or absence of a target route in the case a plurality of branch road guide lines exists in the driving lane.

The controller 140 or the sensor device 110 is configured to perform the first function by analyzing the image of the driving lane and checking whether two or more solid lines having a line width in a range and color exist in a specific area within the left and right lanes of the driving lane.

For example, in the case that a solid line having a width of 40 to 50 cm and a color of green, light green, or pink is detected based on the result detected or output by the sensor device 110, when is detected within a driving lane, the controller 140 recognizes the corresponding solid line as a branch road guide line.

As an example, if a target route is set, the controller 140 controls the lane keeping control module 130 so that the vehicle travels along a branch road guide line corresponding to a target route among the plurality of branch road guide lines.

More specifically, if the target route is set, the controller 140 controls the lane keeping control module 130 so that an outer line of the vehicle is located at a midpoint between a position of one side of a branch road guide line corresponding to a target route among the plurality of branch road guide lines and a position of one side of a left lane or right lane of the driving lane.

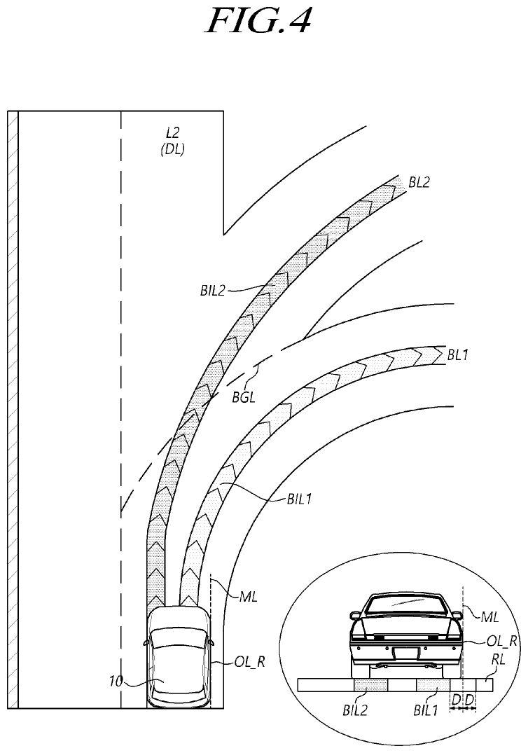

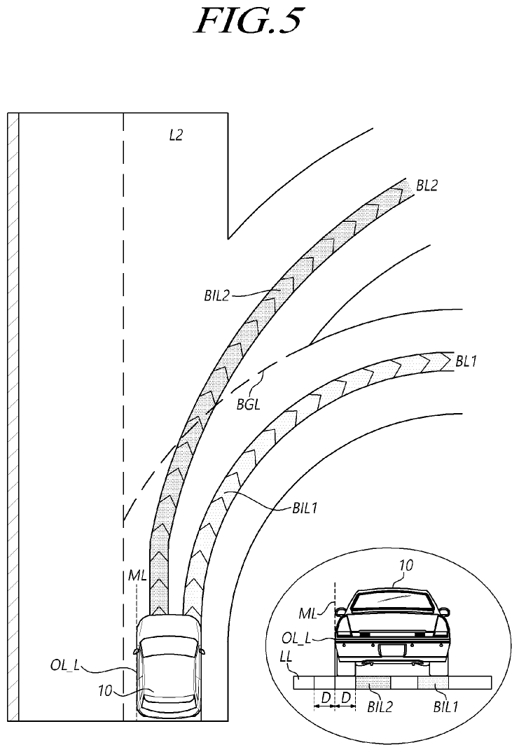

This example will be described in more detail below with reference to FIGS. 4 and 5.

As another example, if the target route is not set, the controller 140 controls the lane keeping control module 130 so that a vehicle drives along a branch road guide line corresponding to a road branching later among the plurality of branch road guide lines.

More specifically, if the target route is not set, the controller 140 controls the lane keeping control module 130 so that a vehicle drives along a branch road guide line having a large radius of curvature among the plurality of branch road guide lines.

Alternatively, in the case that the target route is not set and the a turn signal lamp is turned on, the controller 140 is configured to control the lane keeping control module 130 so that a vehicle drives along a branch road guide line on a side indicated by the turn signal lamp.

Alternatively, in the case that the target route is not set, the controller 140 is configured to control the lane keeping control module 130 so that a vehicle drives along a branch road guide line in a direction of a line of sight of a driver among the plurality of branch road guide lines.

To this end, the sensor device 110 may further include an internal camera sensor mounted inside the vehicle to capture the eye or a pupil of the driver.

The internal camera sensor is configured to capture an image of the driver's pupil, detect a direction (left or right side of the vehicle) in which the driver's line of sight is directed for a predetermined reference time or more, and output the information thereon.

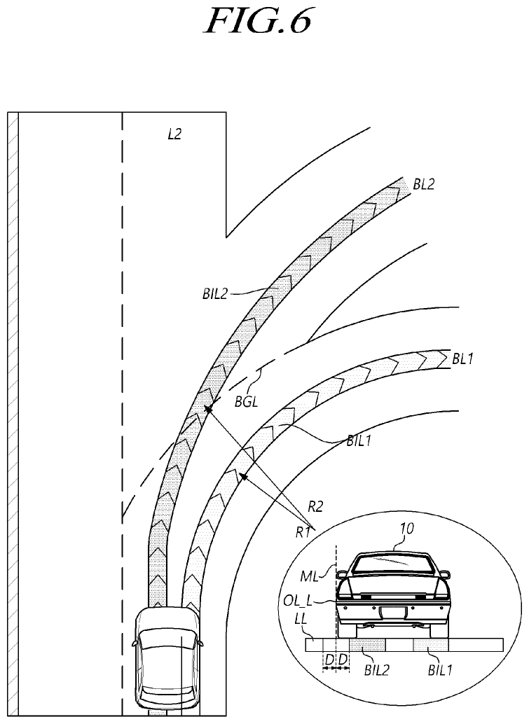

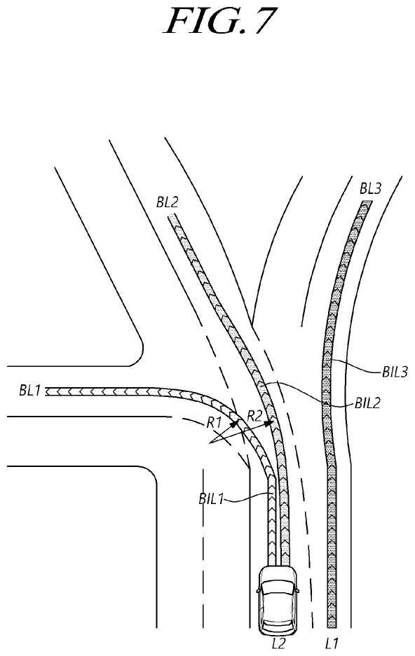

This example will be described in more detail below with reference to FIGS. 6 and 7.

The plurality of branch road guide lines marked in one driving lane includes a first branch road guide line corresponding to a first branch road branching first and a second branch road guide line corresponding to a second branch road branching later.

In this case, each of the first branch road guide line and the second branch road guide line is a line having the same width, and the first branch road guide line and the second branch road guide line may be spaced apart by a first distance within the driving lane and disposed on the left and right.

In addition, the sensor device of the vehicle control device is configured to further detect a branching guide lane marked in the driving lane with the plurality of branch road guide lines.

In some embodiments, the branching guide lane is a white dotted line which starts from one of the left and right lanes of the driving road and extends to one of the left and right lanes of the branch road.

Meanwhile, the controller 140 is configured to control the lane keeping control module 130 to ignore the branching guide lane detected within the driving lane.

That is, in some embodiments, the vehicle control device ignores the branching guide lane and controls the steering of the vehicle based on the branch road guide line even if the branching guide lane is further detected within a driving lane on which a plurality of branch road guide lines are marked.

According to the vehicle control device according to some embodiments as described above, it is possible to control driving of a vehicle in a desired direction in a road area where a plurality of branch roads exist.

Specifically, according to some embodiments of the present disclosure, in the case that a vehicle travels in a lane marked with two or more branch road guide lines, there may be performed autonomous driving control or lane keeping control within the driving lane depending on the presence or absence of a preset target route.

Therefore, it is possible to provide a safe and comfortable vehicle autonomous driving on a road marked with two or more branch road guide lines.

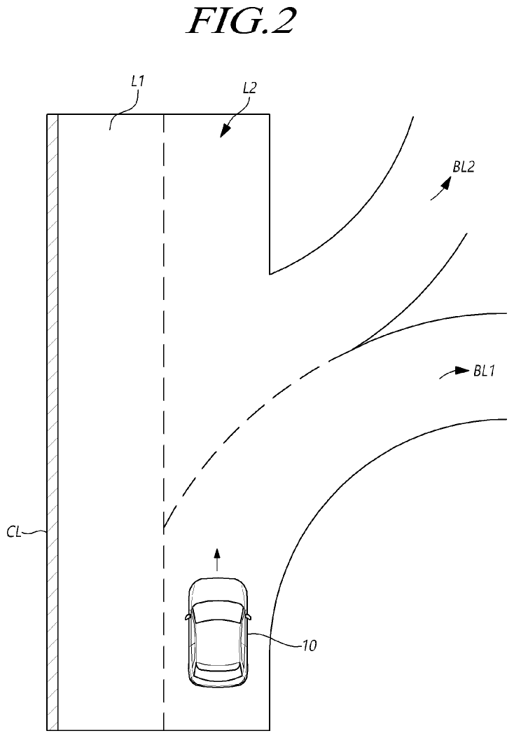

FIG. 2 illustrates a road environment to which some embodiments of the present disclosure is applied.

Referring to FIG. 2, a road on which vehicle control according to the present disclosure is performed may be a one-way two-lane road, and include two driving lanes L1 and L2 on the right side of a center separation line CL.

It is assumed that a host vehicle 10 is driving in L2, which is the outer lane among the two lanes. That is, L2 is a driving lane.

Meanwhile, in front of the driving lane L2, there are two branch roads, BL1 and Bl2, which diverge and proceed in two different paths.

If there is only one branch road ahead, it is not difficult to enter the branch road, and there is no great difficulty in guiding a vehicle in the direction of the branch road.

However, as shown in FIG. 2, in the case that a plurality of branch roads each having different route exist in a close distance, it is difficult for a driver to recognize a desired route.

In addition, even in the case of an autonomous vehicle, it may be difficult to control driving by selecting one of two or more branch road.

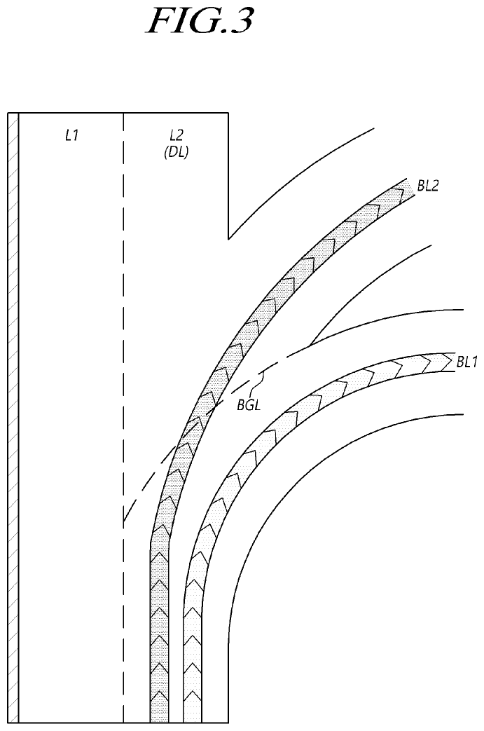

FIG. 3 illustrates an example of a road with a plurality of branch road guide lines marked on a road surface.

Referring to FIG. 3, in a road environment as shown in FIG. 2, a plurality of branch road guide lines is marked or displayed in s within one driving lane for vehicle driving guidance.

For example, two branch road guide lines BIL1 and BIL2 are marked in the driving lane L2.

A first branch road guide line BIL1 is a solid line that first diverges from the driving lane L2 and extends to the center of a first branch road BL1 having a first route.

A second branch road guide line BIL2 is a solid line that branches later from the driving lane L2 and extends to the center of a second branch road BL2 having a second route.

That is, in a roadway L2 having two branch roads branching in the front, a first branch road guide line BILL and a second branch road guide line BIL2, which are two branch road guide lines, are simultaneously marked or displayed from a point a specific distance away from the branching point.

According to Korean standards, the first branch road guide line BIL1 and the second branch road guide line BIL2 are colored solid lines having a constant line width with a first color (pink or green) and a second color (green or pink), respectively, but are not limited thereto.

If two or more branch road guide lines are marked or displayed on one road, the driver may drive along a branch road guide line following a desired driving path.

In addition, an autonomous driving vehicle may select and follow one of the two branch road guide lines displayed on one driving lane.

Meanwhile, in the road environment as shown in FIG. 3, a branching guide lane BGL for guiding two branch roads BL1 and BL2 is further displayed.

The branching guide lane starts from a left lane of the driving lane L2 and extends between the two branch roads BL1 and BL2, and is a dotted white lane like a general lane.

Such a branching guide lane BGL is for guidance from a driving road to a branch road, but may be unnecessary information in the vehicle control device according to the present disclosure.

That is, since the vehicle control device according to some embodiments of the present disclosure controls a lateral position of the vehicle based only on the branch road guide line and the one-side lane of the driving lane, the branching guide lane BGL additionally displayed within the driving lane may be information that is not necessary for control.

Therefore, even if the branching guide lane BGL in the driving lane is further detected, the vehicle control device according to some embodiments of the present disclosure ignores the branching guide lane BGL and controls the lateral position of the vehicle based only on the branch road guide line and one side of the driving lane.

The vehicle control device according to some embodiments of the present disclosure is configured to operate in a road environment in which two or more branch road guide lines are displayed on one driving lane as shown in FIG. 3.

In the case that two or more branch road guide lines are displayed in one driving lane, there may be a problem that the conventional lane keeping control or lane following control system may not be applied.

In addition, if a vehicle travels in the center of a driving lane by applying the conventional lane following control system, there may be performed a rapid steering at a branching point, thereby degrading the driving stability.

For example, if it is desired to drive on the first branch road BL1 in the road environment as shown in FIG. 3, there may be preferable to drive at a position close to the first branch road BL1 rather than the center of the driving lane even before reaching the branching point.

Accordingly, in a road environment in which two or more branch road guide lines are marked on one driving lane, the vehicle control device according to some embodiments controls a vehicle to safely follow one of the plurality of branch road guide lines depending on the presence or absence of a set target route or a target path.

FIG. 4 illustrates an example of an operation of a vehicle control device according to some embodiments of the present disclosure in the case that a target route is set.

The controller 140 of the vehicle control device according to some embodiments of the present disclosure is configured to perform i) a first function of determining whether a plurality of branch road guide lines exists in a driving lane based on data from a sensor device, and ii) a second function of determining whether a target route set by a driver exists.

As a result of performing the first function and the second function, if it is determined that a plurality of branch road guide lines exist in a current driving lane and a target route is set by a navigation device, the controller 140 controls steering of the vehicle so as for the vehicle to drive along a branch road guide line corresponding to the target route among the plurality of branch road guide lines.

For example, the controller 140 is configured to control the lane keeping control module 130 so that an outer line of the vehicle is located at a midpoint between a position on one side of a branch road guide line corresponding to a target route among a plurality of branch road guide lines and a position on one side of a left lane or right lane of the driving lane.

FIG. 4 illustrates a case in which the target route includes a first branch road BL1.

As shown in FIG. 4, the vehicle 10 is traveling on a driving lane L2, and a first branch road guide line BIL1 extending to a first branch road BL1 branching first and a second branch road guide line BIL2 extending to a second branch road BL2 branching later are displayed on the left and right in the driving lane L2.

In this state, it is assumed that the target route set for the vehicle 10 includes the first branch road BL1.

As shown in FIG. 4, in the case that the target route is set to proceed from L2, which is the driving lane DL, to the first branch road BL1, the vehicle control device according to the present embodiment controls the lane keeping control module 130 so that a right outer line of the vehicle 10 is located at the midpoint between a right point of the first branch road guide line BIL1 corresponding to the target route among the plurality of branch road guide lines and a point on a right lane of the driving lane L2.

Specifically, as shown in the lower right of FIG. 4, the vehicle control device controls the lane keeping control module 130 so that a right outer line OL_R of the vehicle 10 is located at the midpoint ML spaced apart by the same distance D from a right point of the first branch road guide line BIL1 and a left end point of the right lane RL of the driving lane L2.

To this end, the controller 140 uses pre-stored vehicle width information W, lateral center location information of the vehicle acquired by the sensor device 110, location information of one end point of a branch road guide line, location information of an end point of a lane on one side of a driving lane, vehicle heading angle information, road curvature (radius) information, and the like.

It will be described a detailed configuration of controlling the lateral position of the vehicle within the driving lane using such information in more detail below based on FIG. 8.

According to the above control, the vehicle 10 may be safely guided to the first branch road BL1 corresponding to the target route.

As such, if the target route includes the first branch road BL1, the vehicle control device according to the present embodiment performs lane following control or lane keeping control based on a position of the first branch road guide line BILL and a right lane of the driving lane rather than performing lane following control based on the left and right lanes of the driving lane L2.

Thus, even before the vehicle 10 reaches the branching point, the vehicle may travel in a lateral position closer to the first branch road BL1 within the driving lane than in the center of the driving lane.

Accordingly, the embodiments of the present disclosure make it possible to minimize a steering angle change or a steering angle change rate in a process of branching into the first branch road BL1, and thus deterioration of steering feeling or driving stability due to branching may be minimized.

FIG. 5 illustrates another example of an operation of a vehicle control device according to some embodiments of the present disclosure in the case that a target route is set.

FIG. 5 illustrates a case in which a plurality of branch road guide lines BIL1 and BIL2 are marked in the driving lane and the target route includes a second branch road BL1.

As shown in FIG. 5, the vehicle 10 is traveling on a driving lane L2, and a first branch road guide line BIL1 extending to a first branch road BL1 branching first and a second branch road guide line BIL2 extending to a second branch road BL2 branching later are marked on the left and right in the driving lane L2.

In this state, it is assumed that the target route set for the vehicle 10 includes the second branch road BL2.

As shown in FIG. 5, in the case that the target route is set to proceed from L2, which is the driving lane DL, to the second branch road BL2, the vehicle control device according to some embodiments controls the lane keeping control module 130 so that a left outer line of the vehicle 10 is located at the midpoint between a right point of the second branch road guide line BIL2 corresponding to the target route among the plurality of branch road guide lines and a right end point of a left lane of the driving lane L2.

Specifically, as shown in the lower right of FIG. 5, the vehicle control device controls the lane keeping control module 130 so that a left outer line OL_L of the vehicle 10 is located at the midpoint ML spaced apart by the same distance D from a left point of the second branch road guide line BIL2 and a right end point of the left lane LL of the driving lane L2.

According to the above control, the vehicle 10 may be safely guided to the second branch road BL2 corresponding to the target route.

Accordingly, in the case that the target route includes a second branch road BL2, even before reaching the branching point, the vehicle 10 may travel in a lateral position closer to the second branch road BL2 within the driving lane than in the center of the driving lane.

Accordingly, the embodiments of the present disclosure make it possible to minimize a steering angle change or a steering angle change rate in a process of branching into the second branch road BL2, and thus deterioration of steering feeling or driving stability due to branching may be minimized.

FIG. 6 illustrates an example of an operation of a vehicle control device according to some embodiments of the present disclosure in the case that a target route is not set.

The controller 140 of the vehicle control device according to some embodiments of the present disclosure is configured to perform i) a first function of determining whether a plurality of branch road guide lines exists in a driving lane based on data from a sensor device, and ii) a second function of determining whether a target route set by a driver exists.

As a result of performing the first function and the second function, if it is determined that a plurality of branch road guide lines exist in a current driving lane and a target route is not set by a navigation device, the controller 140 controls steering of the vehicle so as for the vehicle to drive along a branch road guide line corresponding to a branch road branching later among the plurality of branch road guide lines.

For example, the controller 140 is configured to control the lane keeping control module 130 so that an outer line of the vehicle is located at a midpoint between a position on one side of a left branch road guide line corresponding to a branch road branching later a plurality of branch road guide lines and a position on one side of a left lane or right lane of the driving lane.

As shown in FIG. 6, the vehicle 10 is traveling on a driving lane L2, and a first branch road guide line BIL1 extending to a first branch road BL1 branching first and a second branch road guide line BIL2 extending to a second branch road BL2 branching later are displayed on the left and right on the driving lane L2.

In this state, if there is not a set target route, the vehicle control device according to the some embodiments controls the lane keeping control module 130 so that a left outer line of the vehicle 10 is located at the midpoint between a left point of the second branch road guide line BIL2 corresponding to the second branch road branching later among the plurality of branch road guide lines and a point on a left lane of the driving lane L2.

Specifically, as shown in the lower right of FIG. 6, the vehicle control device controls the lane keeping control module 130 so that a left outer line OL_L of the vehicle 10 is located at the midpoint ML spaced apart by the same distance D from a left point of the second branch road guide line BIL2 and a right end point of the left lane LL of the driving lane L2.

According to the above control, the vehicle 10 may be guided to continue driving along the second branch road BL2 branching later or the current driving road L2.

Alternatively, in the case that there are a plurality of branch road guide lines and a target route is not set by the navigation device or the like, the controller 140 controls the lateral position of the vehicle in the driving lane so that the vehicle follows a branch road guide line with a large radius of curvature among the plurality of branch road guide lines.

That is, in FIG. 6, the radius of curvature R2 of the second branch road guide line BIL2 disposed on the left side is greater than the radius of curvature R1 of the first branch road guide line BIL1 disposed on the right side of the driving road at a specific location.

Therefore, if it is determined that the target route is not set by the navigation device, the controller 140 performs lane keeping control of the vehicle based on the second branch road guide line BIL2, which is a branch road guide line having a large radius of curvature (i.e., a branch road guide line with a small curvature change), among the first branch road guide line BILL and the second branch road guide line BIL2.

In some embodiments, in the case that a plurality of branch road guide lines exist in a current driving lane and a target route is not set by a navigation device, the vehicle control device e controls the vehicle to drive along a branch road guide line in a direction indicated by a turn signal lamp.

The controller 140 is configured to check whether a turn signal lamp or a direction indicator is turned on when the vehicle drives on a driving lane marked with a plurality of branch road guide lines and a target route is not set by a navigation device or the like.

If a turn signal lamp or a direction indicator of the vehicle is turned on while a target route is not set, the controller 140 controls the lane keeping control module 130 so as for a vehicle to drive along a branch road guide line in the direction of the turned-on turn signal lamp among the plurality of branch road guide lines.

Specifically, in the road environment as shown in FIG. 6, if the right turn signal lamp of the vehicle is turned on while the target route is not set, the controller 140 controls the lateral position of the vehicle in the driving lane based on the first branch road guide line BIL1 corresponding to the first branch road BL1 which branches first.

Alternatively, in the case that the turn signal lamps are not turned on or the left turn signal lamp is turned on, as described above, the controller 140 controls the lateral position of the vehicle based on the second branch road guide line BIL2 corresponding to the second branch road BL2, which branched later, or the second branch road guide line BIL2 having a large radius of curvature.

As another example, in the case that a target route is not set, the controller 140 controls the lane keeping control module 130 so that the vehicle drives along a branch road guide line in a side of driver's line of sight among the plurality of branch road guide lines.

An internal camera sensor included in the sensor device 110 is configured to capture images in the direction of the driver's face and/or eyes to check a position of a pupil. The sensor device 110 is configured to determine whether the line of sight of the driver is directed to the left side or the right side in front of the vehicle based on the detected face direction and/or pupil position.

More specifically, the internal camera sensor is configured to capture the image in the direction of a face or a pupil of the vehicle driver, detect a direction (left or right side of the vehicle) that the driver's gaze is directed for more than a predetermined reference time, and output the information on the direction of driver's line of sight.

If the vehicle drives on a driving lane marked with a plurality of branch road guide lines and the target route is not set by a navigation device or the like, the controller 140 controls the lane keeping control module based on a branch road guide line in the direction of the driver's line of sight.

For example, in the environment of FIG. 6, if the driver's line of sight is directed to the right, the controller 140 controls the lateral position of the vehicle in the driving lane so that a right outer line OL_R of the vehicle is located at the midpoint between the right end position of the first branch road guide line BIL1 corresponding to the first branch road BL1, which branched first, and the left end position of the right lane of the driving lane.

In this way, in the case that the target route is not set, the vehicle control device according to some embodiments controls the vehicle to drive along a branch road guide line, which has a large radius of curvature or branches later, or to drive along a branch road guide line in a direction of the driver's line of sight or a direction indicated by a turn signal lamp.

Accordingly, even if the target route is not set, it is possible to optimally maintain the driving direction of the vehicle by allowing the vehicle to continue driving on the driving lane without branching or driving along a branch road branching later.

FIG. 7 illustrates another example of an operation of a vehicle control device according to some embodiments of the present disclosure in the case that a target route is not set.

FIG. 7 illustrates an environment of an at-grade intersection or a level intersection.

That is, in the intersection area, there is a first branch road BL1 that proceeds rapidly to the left from the driving lane L2, which is a first lane, a second branch road BL2 that proceeds gently to the left from the driving lane L2, and a third branch road BL3 that proceeds to the right from the adjacent lane L1, which is a second lane.

In this case, on the driving lane L2 corresponding to the left turn lane, there is simultaneously marked a first branch road guide line BIL1 for guiding to a first branch road L1 (i.e., a sharp left turn) and a second branch road guide line BIL2 for guiding to a second branch road L2 (i.e., a gentle left turn).

In addition, a third branch road guide line BIL3 is displayed for guiding to a third branch road BL3 in the adjacent lane L1 corresponding to the right turn lane.

A road environment shown in FIG. 7 may occur not only at an intersection area but also in a case in which a lane diverges to the center or left on a highway and then merges again.

As shown in FIG. 7, a “branch road” in the present disclosure is a concept including left/right turning roads in an intersection area as well as left/right branching of a driving road.

In the road environment as shown in FIG. 7, if the vehicle travels on the driving lane L2 and the target route is not set by the route guidance device, the vehicle control device according to some embodiments of the present disclosure controls the lateral position of the vehicle in the driving lane in order for the vehicle to follow a branch road guide line having a large radius of curvature among a plurality of branch road guide lines.

That is, in FIG. 7, a radius of curvature R2 of a second branch road guide line BIL2 arranged on the left is greater than a radius of curvature R1 of a first branch road guide line BIL1 in the intersection area.

Accordingly, if it is determined that the target route is not set by the navigation device, the controller 140 performs lane keeping control of the vehicle based on the second branch road guide line BIL2, which is a branch road guide line having a large radius of curvature (i.e., a branch road guide line with a small curvature change) among the first branch road guide line BILL and the second branch road guide line BIL2.

Specifically, in some embodiments of FIG. 7, the controller 140 is configured to control the lateral position of the vehicle in the driving lane so that a right outer line of the vehicle is disposed at the midpoint between the second branch road guide line BIL2 to be followed, and a right lane of the driving lane L2 and a left turn guide line extending therefrom.

Accordingly, in the case that the target route is not set, it is possible to optimally maintain the driving direction of the vehicle by controlling the vehicle to travel along a branch road with a large radius of curvature or a left/right turn branch road.

FIG. 8 illustrates an example of a configuration for following a branch road guide line of a vehicle control device according to some embodiments.

The vehicle control device according to some embodiments of the present disclosure previously stores vehicle width information W of the vehicle.

In addition, the sensor device 110, such as a front camera module, is configured to calculate and output an edge of a branch road guide line or a lane marked on a driving lane, and position information (coordinates, etc.) of the corresponding edge.

In addition, since the front camera module is installed in the center of the front of the vehicle, it is possible to output position information (coordinates, etc.) of an end points of the left and right outer lines of the vehicle or the center in the lateral direction of the vehicle, and calculate and output a vehicle heading angle, which is an angle between a branch road guide line or one side lane of a driving lane and a driving direction of the vehicle.

In addition, the front camera module is configured to recognize left and right lanes of the driving lane and output curvature or radius of curvature information of the lane and forward direction information of the lane.

That is, referring to FIG. 8, the vehicle control device acquires, based on the pre-stored information and the information detected by the sensor device 110, a coordinates (xc, yc) of the center of the vehicle in the lateral direction, a coordinates (x1, y1) of a left end point of the branch road guide line BIL, a coordinates (x2, y2) of an end point of the left outer line of the vehicle, and a coordinates (x3, y3) of a right end point of the left lane LL of the driving lane.

For convenience of calculation, it is assumed that the traveling direction or the driving direction of the vehicle is the y-axis and the lateral direction perpendicular to the y-axis is the x-axis.

That is, it is assumed that a lateral distance between a plurality of points is determined only by the difference in x-coordinates.

In this case, the vehicle control device according to some embodiments is configured to control the lane keeping control module so that an outer line of the vehicle is located at the midpoint between the position on one side of the branch road guide line to be followed and the position on the left or right lane of the driving lane.

Referring to FIG. 8 again, the vehicle control device is configured to determine the position x2 of the end point of the left outer line of the vehicle based on the midpoint xc of the vehicle in the lateral direction and the vehicle width information W.

In addition, the position x1 of the left end point of the branch road guide line BIL and the position x3 of the right end point of the left lane LL of the driving lane are also determined based on the signal transmitted from the sensor device.

The controller 140 of the vehicle control device is configured to monitor the position x2 of the end point of the left outer line the vehicle and the midpoint (x3−x1) between the left end point x1 of the branch road guide line BIL and the right end point x3 of the left lane of the driving lane in real time while driving the vehicle, and control the vehicle steering device so that a position error, which is the difference between x2 and (x3−x1), converges to zero.

For example, if the distance (x3−xc) from the center of the vehicle (xc) to the right end point (x3) of the left lane LL of the driving lane is 1.5 m and the distance (x1−xc) between the left end point (x1) of the branch road guide line BIL from the vehicle center (xc) is 0.7 m, the end point (x2) of the left outer line of the vehicle may be (xc+W/2).

Accordingly, the controller 140 controls the lateral position of the vehicle within the driving road so that the end point (x2) of the left outer line of the vehicle (OL_L) is located at a position of a middle of the left end point (x1) of the branch road guide line and the right end point (x3) of the left lane of the driving lane, that is, a midpoint spaced 0.4 m, the same distance, from the left end point (x1) of the branch road guide line and the right end point (x3) of the left lane of the driving lane.

Specifically, the controller 140 of the vehicle control device continuously monitors the distance error Δd, which is defined as a difference between the end point position (x2) of the left outer line of the vehicle determined from the current position of the vehicle, and a position of the midpoint (x3−x1) between the left end point (x1) of the branch road guide line BIL and the right end point (x3) of the left lane LL of the driving lane determined through image analysis.

If the distance error Δd exceeds a predetermined threshold value, the controller 140 controls the distance error Δd to decrease by changing the vehicle steering angle through the lane keeping control module 130.

In conclusion, the controller 140 of the vehicle control device according to some embodiments of the present disclosure is configured to continuously change the vehicle steering angle through the lane keeping control module 130 so that the distance error Δd becomes zero.

Meanwhile, even if the position of the outer line of the vehicle is at the above-described position, if there is an error in the driving direction of the vehicle, there may not be performed a correct lane following control.

Accordingly, the controller 140 of the vehicle control device according to some embodiments of the present disclosure is configured to further control the lane keeping control module 130 based on a vehicle heading angle.

Specifically, the controller 140 controls the lane keeping control module 130 so that the vehicle heading angle θh, which is defined as the relative angle of the driving direction of the vehicle with respect to a direction vector θr of a branch road guide line of a driving lane, converges to 0.

That is, the controller 140 continuously monitors the vehicle heading angle θh output from the sensor device 110, and continuously adjusts the vehicle steering angle through the lane keeping control module 130 so that the vehicle heading angle θh becomes zero.

Accordingly, the controller 140 is configured to continuously control the vehicle steering direction so that the distance error Δd and the vehicle heading angle θh converge to 0, thereby following the branch road guide line according to some embodiments of the present disclosure.

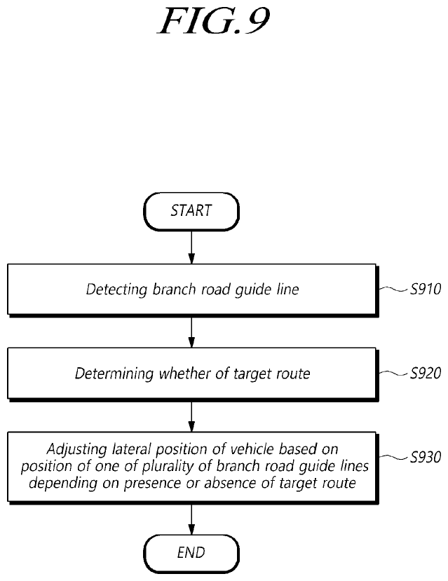

FIG. 9 is a flowchart of a vehicle control method according to some embodiments of the present disclosure.

The vehicle control method according to some embodiments of the present disclosure includes detecting a branch road guide line (S910), generating a target route to a destination and providing information on the target route (S920), and adjusting, if a plurality of branch road guide lines is detected in one driving lane, a lateral position of the vehicle in the one driving lane based on a positions of one or more of the plurality of branch road guide lines and a position of the left or right lanes of the driving lane depending on whether the target route is set (S930).

In step S930, if the target route is set, the lateral position of the vehicle is adjusted so that the vehicle travels along a branch road guide line corresponding to the target route among the plurality of branch road guide lines.

More specifically, if the target route is set, the lateral position of the vehicle is adjusted so that an outer line of the vehicle is positioned at a midpoint between a position on one side of a branch road guide line corresponding to the target route among the plurality of branch road guide lines and a position on one side of the left lane or right lane of the driving lane.

In addition, in step S930, if a target route is not set, the lateral position of the vehicle is adjusted so that the vehicle drives along a branch road guide line corresponding to a branch road branching later among the plurality of branch road guide lines or a branch road guide line having a large curvature radius.

As another example, in step S930, if a target route is not set, the lateral position of the vehicle is adjusted so that the vehicle drives along a branch road guide line to a side indicated by a turn signal lamp, or a branch road guide line to the side of the driver's line of sight.

In addition, the vehicle control method according to some embodiments of the present disclosure further includes identifying a branching guide lane within a driving lane on which a plurality of branch road guide lines are displayed. In this case, in step S930, the lateral position of the vehicle is controlled by ignoring the branching guide lane identified within the driving lane.

Since the vehicle control method as shown in FIG. 9 according to some embodiments is performed by the vehicle control device described based on FIGS. 2 to 8, a detailed description of each step will be omitted.

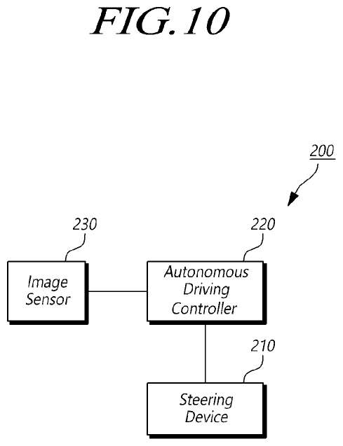

FIG. 10 is a configuration diagram of a vehicle control device for autonomous driving according to some embodiments of the present disclosure.

According to some embodiments of the present disclosure, a vehicle control device 200 for autonomous driving is provided.

The vehicle control device according to FIGS. 2 to 8 in some embodiments is installed in a general vehicle equipped with a driver assistance system (DAS), and performs a control of following of a branch road guide line as one of the lane keeping control or lane following control functions.

Meanwhile, according to some embodiments of the present disclosure, the vehicle control device 200 is used as a control device for fully autonomous driving.

Specifically, the vehicle control device 200 according to some embodiments of the present disclosure includes a steering device 210 for controlling the driving direction of a vehicle and an autonomous driving controller 220 for controlling an autonomous driving of the vehicle by controlling the steering device without an intervention of a driver.

In this case, the autonomous driving controller 220 is configured to detect a plurality of branch road guide lines marked on a road surface of one driving lane in which a vehicle travels based on information from an image sensor mounted in the vehicle, and adjust a lateral position of the vehicle within the one driving lane by automatically controlling the steering device based on one or more of the plurality of branch road guide lines depending on the presence or absence of a target route set for autonomous driving of the vehicle.

Specifically, the autonomous driving controller 220 is configured to perform i) a first function of detecting a plurality of branch road guide line marked on a road surface of one driving lane in which the vehicle is driving based on information from the image sensor 230 mounted on the vehicle, ii) a second function of determining whether a target route is set by a route guidance device for autonomous driving of a vehicle, and iii) a third function of adjusting the lateral position of the vehicle within the one driving lane by automatically controlling the steering device based on one or more of a plurality of branch road guide lines depending on the presence or absence of the target route.

Specifically, if a target route for autonomous driving is set, the autonomous driving controller 220 controls the steering device 210 so that the vehicle travels along a branch road guide line corresponding to a target route among the plurality of branch road guide lines.

More specifically, if a target route for autonomous driving is set, the autonomous driving controller 220 controls the steering device 210 so that an outer line of the vehicle is located at a midpoint between a position of one side of a branch road guide line corresponding to a target route among the plurality of branch road guide lines and a position of one side of a left lane or right lane of the driving lane.

Meanwhile, if a target route for autonomous driving is not set, the autonomous driving controller 220 controls the steering device 210 so that a vehicle drives along a branch road guide line corresponding to a road branching later among the plurality of branch road guide lines, or a branch road guide line having a large radius of curvature among the plurality of branch road guide lines.

Alternatively, in the case that a target route for autonomous driving is not set, the autonomous driving controller 220 controls the steering device 210 so that a vehicle drives along a branch road guide line on a side indicated by the turn signal lamp, or a branch road guide line in a direction of a line of sight of a driver among the plurality of branch road guide lines.

The autonomous driving controller 220 of the vehicle control device shown in FIG. 10 in some embodiments has the corresponding configuration as a sensor device, a route guidance device, lane keeping control module, and controller of the vehicle control device described based on FIGS. 2 to 8. Therefore, a detailed description of the configuration will be omitted.

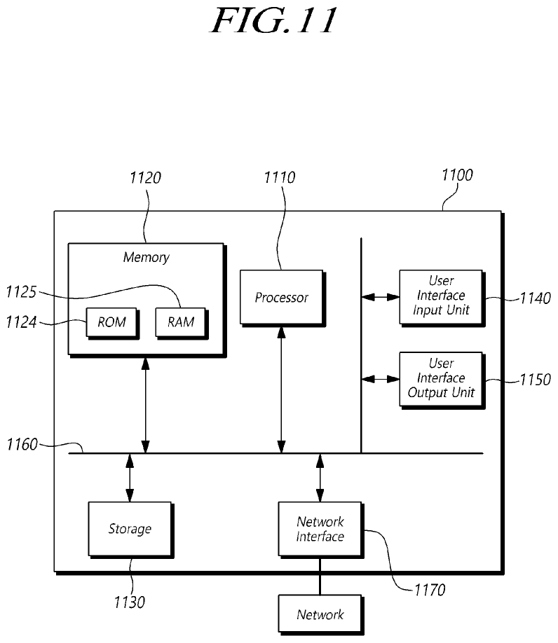

FIG. 11 illustrates an example of a hardware configuration of a vehicle control device according to some embodiments of the present disclosure.

Referring to FIG. 11, the vehicle control device 100 and 200, and the route guidance device 120, the lane keeping control module 130, the controller 140 and the autonomous driving controller 220 included therein according to the above-described embodiments are implemented with hardware or software implemented in a computer system.

That is, the vehicle control device 100 and 200, the route guidance device 120, the lane keeping control module 130, the controller 140 and the autonomous driving controller 220 are implemented as a computer device having hardware as shown in FIG. 11.

As shown in FIG. 11, a computer system 1100, which is an implementation form of the vehicle control device 100 and 200, and the route guidance device 120, the lane keeping control module 130, the controller 140 and the autonomous driving controller 220 included therein, includes one or more elements of one or more processors 1110, a memory 1120, a storage 1130, a user interface input unit 1140, and a user interface output unit 1150, and the elements communicate with each other through a bus 1160.

In addition, the computer system 1100 also includes a network interface 1170 for connecting to a network. The processor 1110 includes a central processing unit (CPU) or a semiconductor device that executes processing instructions stored in the memory 1120 and/or the storage 1130. The memory 1120 and the storage 1130 includes various types of volatile/nonvolatile storage media. For example, the memory includes a read-only memory (ROM) 1124 and a random access memory (RAM) 1125.

In addition, a software module performing a function of the route guidance device 120, the lane keeping control module 130, the controller 140 and the autonomous driving controller 220 constituting the vehicle control device according to the some embodiments is installed in the computer system 1100 used in the present embodiment.

Specifically, in the computer system 1100, there is installed a software module for setting a target route, a software module for lane keeping control controlled by a controller to control a lateral position of a vehicle, and a software module for controlling the lateral position of a vehicle within a driving lane based on the position of a branch road guide line and the position of a lane on one side of a driving lane depending on the presence or absence of the target route.

The processor (main control unit (MCU) 1110) of the vehicle control device according to the some embodiments executes the above-described software module stored in the storage 1130 or the memory 1120 to perform a corresponding function.

As described above, according to the vehicle control device of some embodiments, in the case that a vehicle drives in a lane marked with two or more branch road guide lines, it is possible to appropriately perform the autonomous driving control or lane keeping control within the driving lane depending on the presence or absence of a preset target route.

In particular, the vehicle control device of some embodiments provides safe and comfortable autonomous driving or lane keeping control in driving lanes marked with two or more branch road guide lines.

It should be noted that although all or some of the configurations or elements included in one or more of the embodiments described above have been combined to constitute a single configuration or component or operated in combination, the present disclosure is not necessarily limited thereto. That is, within the scope of the object or spirit of the present disclosure, all or some of the configurations or elements included in the one or more of the embodiments may be combined to constitute one or more configurations or components or operated in such combined configuration(s) or component(s). Further, each of the configurations or elements included in one or more of the embodiments may be implemented by an independent hardware configuration; however, some or all of the configurations or elements may be selectively combined and implemented by one or more computer program(s) having one or more program module(s) that perform some or all functions from one or more combined hardware configuration(s). Codes or code segments constituting the computer program(s) may be easily produced by those skilled in the art. As the computer programs stored in computer-readable media are read and executed by a computer, embodiments of the present disclosure can be implemented. The media for storing computer programs may include, for example, a magnetic storing medium, an optical recording medium, and a carrier wave medium.

Further, unless otherwise specified herein, terms ‘include’, ‘comprise’, ‘constitute’, ‘have’, and the like described herein mean that one or more other configurations or elements may be further included in a corresponding configuration or element. Unless otherwise defined herein, all the terms used herein including technical and scientific terms have the same meaning as those understood by those skilled in the art. The terms generally used such as those defined in dictionaries should be construed as being the same as the meanings in the context of the related art and should not be construed as being ideal or excessively formal meanings, unless otherwise defined herein.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. A vehicle control device comprising:
a sensor device configured to detect a branch road guide line marked on a road surface of a driving lane;
a route guidance device configured to generate a target route to a destination and provide information on the target route;
a lane keeping control module configured to perform a lane keeping control; and
a controller configured to, in response to a plurality of branch road guide lines being detected in the driving lane, control the lane keeping control module based on (i) a position of at least one of the plurality of branch road guide lines and (ii) a position of a left lane or a right lane of the driving lane depending on a presence or absence of the target route set by the route guidance device.

2. The vehicle control device of claim 1, wherein, in response to the target route being set, the controller is configured to control the lane keeping control module to cause a vehicle to drive along a branch road guide line corresponding to the target route among the plurality of branch road guide lines.

3. The vehicle control device of claim 2, wherein, in response to the target route being set, the controller is configured to control the lane keeping control module to cause an outer line of the vehicle to be located at a midpoint position between one side of the branch road guide line corresponding to the target route among the plurality of branch road guide lines and one side of the left lane or right lane of the driving lane.

4. The vehicle control device of claim 1, wherein, when the target route is not set, the controller is configured to control the lane keeping control module to cause a vehicle to drive along a branch road guide line corresponding to a road branching later among the plurality of branch road guide lines.

5. The vehicle control device of claim 1, wherein, when the target route is not set, the controller is configured to control the lane keeping control module to cause a vehicle to drive along at least one of a branch road guide line having a large radius of curvature among the plurality of branch road guide lines, a branch road guide line on a side indicated by a turn signal lamp, or a branch road guide line on a side of a line of sight of a driver of the vehicle.

6. The vehicle control device of claim 1, wherein the plurality of branch road guide lines are each distinguished by a different color or pattern.

7. The vehicle control device of claim 1, wherein the plurality of branch road guide lines comprises a first branch road guide line corresponding to a first branch road branching first and a second branch road guide line corresponding to a second branch road branching later.

8. The vehicle control device of claim 7, wherein each of the first branch road guide line and the second branch road guide line is a line having the same width, and the first branch road guide line and the second branch road guide line are spaced apart by a first distance within the driving lane and disposed on the left and right.

9. The vehicle control device of claim 1, wherein the route guidance device includes a navigation device built into a vehicle or a portable terminal of a vehicle occupant or a driver, and the controller is configured to receive information about the target route from the route guidance device.

10. The vehicle control device of claim 1, wherein the sensor device is configured to identify
each of the plurality of branch road guide lines based on a width of a branch road guide line marked in the driving lane, and
a color or a pattern of the branch road guide line marked in the driving lane.

11. The vehicle control device of claim 1, wherein the sensor device is configured to further detect a branching guide lane marked in the driving lane with the plurality of branch road guide lines,
wherein the controller is configured to control the lane keeping control module to ignore the branching guide lane detected within the driving lane.

12. A vehicle control device comprising:
a steering device configured to control a driving direction of a vehicle; and
an autonomous driving controller configured to control an autonomous driving of the vehicle by controlling the steering device without an intervention of a driver,
wherein the autonomous driving controller is configured to
detect a plurality of branch road guide lines marked on a road surface of one driving lane in which a vehicle travels based on information from an image sensor mounted in the vehicle, and
adjust a lateral position of the vehicle within the one driving lane by automatically controlling the steering device based on one or more of the plurality of branch road guide lines depending on a presence or absence of a target route set for autonomous driving of the vehicle.

13. The vehicle control device of claim 12, wherein, in response to the target route being set, the autonomous driving controller is configured to control the steering device to cause the vehicle to drive along a branch road guide line corresponding to the target route among the plurality of branch road guide lines.

14. The vehicle control device of claim 12, wherein, in response to the target route being set, the autonomous driving controller is configured to control the steering device to cause an outer line of the vehicle to be located at a midpoint position between one side of the branch road guide line corresponding to the target route among the plurality of branch road guide lines and one side of a left lane or right lane of the driving lane.

15. The vehicle control device of claim 12, wherein, when the target route is not set, the autonomous driving controller is configured to control the steering device to cause the vehicle to drive along a branch road guide line corresponding to a road branching later among the plurality of branch road guide lines.

16. The vehicle control device of claim 12, wherein, when the target route is not set, the autonomous driving controller is configured to control the steering device to cause the vehicle to drive along at least one of a branch road guide line having a large radius of curvature among the plurality of branch road guide lines, a branch road guide line on a side indicated by a turn signal lamp, or a branch road guide line on a side of a line of sight of a driver.

17. A vehicle control method comprising:
detecting a branch road guide line marked on a road surface within one driving lane;
generating a target route to a destination and providing information on the target route; and
adjusting, in response to a plurality of branch road guide lines being detected within the one driving lane, a lateral position of a vehicle in the one driving lane based on (i) a position of at least one of the plurality of branch road guide lines and (ii) a position of a left lane or a right lane of the one driving lane depending on a presence or absence of the target route.

18. The vehicle control method of claim 17, wherein said adjusting the lateral position comprises, in response to the target route being set, adjusting the lateral position of the vehicle to cause the vehicle to drive along a branch road guide line corresponding to the target route among the plurality of branch road guide lines.

19. The vehicle control method of claim 17, wherein said adjusting the lateral position comprises, in response to the target route being set, adjusting the lateral position of the vehicle to cause an outer line of the vehicle to be located at a midpoint position between a position of one side of the branch road guide line corresponding to the target route among the plurality of branch road guide lines and a position of one side of the left lane or right lane of the driving lane.

20. The vehicle control method of claim 17, wherein said adjusting the lateral position comprises, when the target route is not set, adjusting the lateral position of the vehicle to cause the vehicle to drive along a branch road guide line corresponding to a road branching later among the plurality of branch road guide lines.

21. The vehicle control method of claim 17, wherein the adjusting the lateral position comprises, when the target route is not set, adjusting the lateral position of the vehicle to cause the vehicle to drive along at least one of a branch road guide line having a large radius of curvature among the plurality of branch road guide lines, a branch road guide line on a side indicated by a turn signal lamp, or a branch road guide line on a side of a line of sight of a driver.

22. The vehicle control method of claim 17, wherein the plurality of branch road guide lines comprises a first branch road guide line corresponding to a first branch road branching first and a second branch road guide line corresponding to a second branch road branching later.

23. The vehicle control method of claim 17, further comprising detecting a branching guide lane marked in the driving lane with the plurality of branch road guide lines,
wherein said adjusting the lateral position comprises controlling the lateral position of the vehicle by ignoring the branching guide lane detected within the one driving lane.
